(19) United States
(12) Patent Application Publication
(10) Pub. No.: US 2008/0136635 A1
(43) Pub. Date: Jun. 12, 2008

(54) LOW POWER RFID READER THAT GIVES VISIBILITY TO PASSIVE TAGS AS ACTIVE TAGS USING LOW POWER 802.11

(75) Inventor: Ajay MALIK, San Jose, CA (US)

Correspondence Address: INGRASSIA FISHER & LORENZ, P.C., 7010 E. COCHISE ROAD, SCOTTSDALE, AZ, 85253, US

(73) Assignee: SYMBOL TECHNOLOGIES, INC., Holtsville, NY (US)

(21) Appl. No.: 11/608,647

(22) Filed: Dec. 8, 2006

(51) Int. Cl. G01S 1/00; G08B 13/14

(52) U.S. Cl. 340/572.1

(57) ABSTRACT

Apparatus, systems, and methods for enabling a radio frequency identification (RFID) passive tag to be visible as an RFID active tag over an extended period of time are disclosed. An RFID reader transmits a substantially continuous radio frequency (RF) charging signal. In response to receiving the RF charging signal, one or more RFID passive tags each transmit a substantially continuous identifier signal. The RFID reader is configured to receive the identifier signal(s) and to determine a location and/or asset associated with each RFID passive tag.

### TECHNICAL FIELD

The present invention relates generally to radio frequency identification (RFID) devices, systems, wireless local area networks (WLANs), and any other network incorporating RF elements, and, more particularly to a low power RFID reader device and systems incorporating 802.11 or a low power IEEE 802.11 device.

### BACKGROUND

Radio frequency identification (RFID) systems have achieved wide popularity in a number of applications, as they provide a cost-effective way to track the location of a large number of assets in real time. In large-scale applications such as warehouses, retail spaces, and the like, many RFID tags may exist in the environment. Likewise, multiple RFID readers are typically distributed throughout the space in the form of entryway readers, conveyer-belt readers, mobile readers, etc., and may be linked by network controller switches and the like.

Similarly, there has been a dramatic increase in demand for mobile connectivity solutions utilizing various wireless components and wireless local area networks (WLANs). This generally involves the use of wireless access points that communicate with mobile devices using one or more RF channels (e.g., in accordance with one or more of the IEEE 802.11 standards).

Many environments utilizing an RFID system to track assets include one or more active tags. An active tag is RFID tag having its own internal power source which is used to power any ICs so that the active tag is capable of generating a constant outgoing identifier signal. While active tags are effective in tracking assets, active tags are significantly more expensive to implement than passive tags. Therefore, an RFID system that utilizes primarily passive tags would be more cost effective than a system utilizing primarily active tags.

Accordingly, it is desirable to provide apparatus, systems, and methods for enabling passive tags to be visible as active tags. For example, an RFID reader with software and/or hardware capabilities to read the RFID passive tags and transmit the information (e.g., on the air) as active tags, wherein the active tag information (with embedded passive tag information) may be used by, for example, an RF switch or other similar device to locate the passive tags. Other desirable features and characteristics of the present invention will become apparent from the subsequent detailed description and the appended claims, taken in conjunction with the accompanying drawings and the foregoing technical field and background.

### BRIEF SUMMARY

Various embodiments of the present invention provide a radio frequency identification (RFID) system including one or more RFID passive tags configured to receive a substantially continuous charging radio frequency (RF) signal and to transmit a substantially continuous identifier signal in response to receiving the substantially continuous charging RF signal. Moreover, the various embodiments include an RFID reader configured to transmit the substantially continuous charging RF signal and to receive the substantially continuous identifier signal such that the at least one RFID passive tag is visible as an RFID active tag to the RFID reader when transmitting the substantially continuous identifier signal.

In addition, various embodiments of the invention provide a method for enabling an RFID passive tag to be visible as an RFID active tag, wherein the method includes the steps of transmitting, by an RFID reader, a substantially continuous charging RF signal to one or more RFID passive tags, and receiving, by the RFID reader, a substantially continuous identifier signal from the at least one RFID passive tag in response to transmitting the charging RF signal, wherein the transmitting and receiving steps occur over an extended period of time to identify a location of the at least one RFID passive tag. Other various embodiments of the invention provide a method for enabling an RFID passive tag to be visible as an RFID active tag, wherein the method includes the steps of receiving, by one or more RFID passive tags, a substantially continuous charging RF signal from at least one RFID reader, and transmitting, by the one or more RFID passive tags, a respective substantially continuous identifier signal to the at least one RFID reader in response to receiving the charging RF signal, wherein the receiving and transmitting steps occur over an extended period of time to enable a location of the RFID passive tag to be determined. Still other various embodiments of the invention provide a method for enabling an RFID passive tag to be visible as an RFID active tag, wherein the method includes the steps of transmitting, by an RFID reader, a substantially continuous charging RF signal, receiving, by one or more RFID passive tags, the substantially continuous charging RF signal, and transmitting, by each of the one or more RFID passive tags, a respective substantially continuous identifier signal in response to receiving the charging RF signal.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a diagram of one embodiment of a system for enabling a radio frequency identification (RFID) passive tag to be visible as an RFID active tag;

FIG. 2 is a flow diagram representing one embodiment of a method for enabling an RFID passive tag to be visible as an RFID active tag;

FIG. 3 is a flow diagram representing another embodiment of a method for enabling an RFID passive tag to be visible as an RFID active tag; and

FIG. 4 is a flow diagram representing yet another embodiment of a method for enabling an RFID passive tag to be visible as an RFID active tag.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the IEEE 802.11 family of specifications, wireless networks, RFID systems and specifications, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

The present invention relates to devices, systems, and methods for enabling an RFID passive tag to be visible as an RFID active tag. The system provides user-friendly methods of determining the location of RFID passive tags and/or provides methods of determining the type of asset associated with the RFID passive tags.

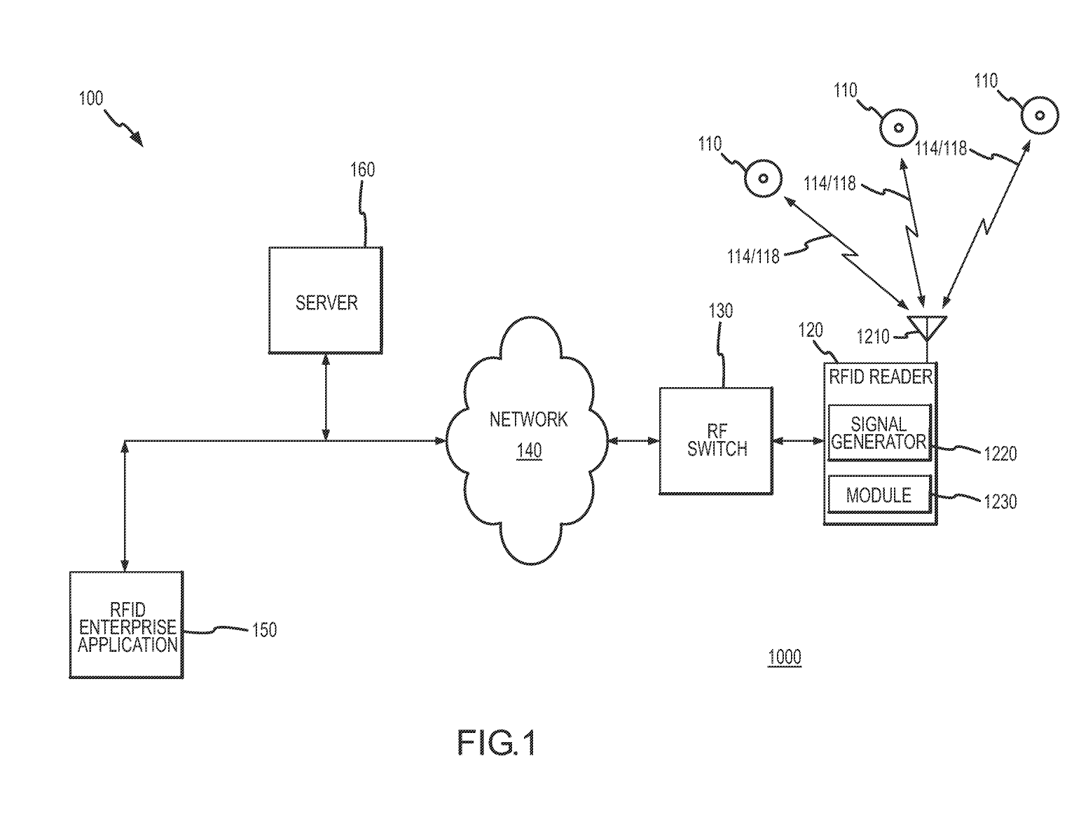

FIG. 1 is a diagram of one embodiment of a system 100 for enabling one or more radio frequency identification (RFID) passive tags 110 to be visible as an RFID active tag to an RFID reader 120. Passive tags 110 may be any device, hardware, and/or software capable of transmitting an identifier signal 114 (e.g., by backscattering) in response to receiving a charging radio frequency (RF) signal 118, wherein identifier signal 114 comprises identifying information for locating purposes and/or information (e.g., type, date of purchase, date of sale, and/or the like) relating to an asset associated with each respective passive tag 110. In one embodiment, passive tags 110 are each an RFID tag having no internal power supply, but include an antenna capable of receiving a substantially continuous charging RF signal 118, which powers the CMOS integrated circuit (not shown) in RFID passive tag 110, and capable of enabling RFID passive tag 110 to transmit (e.g., by backscattering) a substantially continuous identifier signal 114 in response to receiving substantially continuous charging RF signal 118. In another embodiment, RFID passive tags 110 are each RFID passive tags manufactured by Symbol Technologies, Inc. of Holtsville, N.Y.

Although FIG. 1 illustrates system 100 as including three passive tags 110, various embodiments of system 100 contemplate that any number of passive tags 110 may be included as part of system 100. In other words, system 100 may include any number of passive tags 110 greater than zero.

RFID reader 120 may be any device, hardware, and/or software capable of transmitting substantially continuous charging RF signal 118 in accordance with, for example, IEEE 802.11 specifications. Moreover, RFID reader 120 may also include any device, hardware, and/or software capable of receiving substantially continuous identifier signal 114. In one embodiment, RFID reader 120 includes a signal generator 1220 configured to generate a substantially continuous charging RF signal (e.g., substantially continuous charging RF signal 118) capable of charging one or more external devices (e.g., passive tags 110). Furthermore, RFID reader 120 includes a module 1230 suitably configured to receive substantially continuous identifier signals (e.g., substantially continuous identifier signals 114) from one or more external devices (e.g., passive tags 110), and determine the location of the one or more devices and/or determine a asset associated with the one or more devices based upon information included within each substantially continuous identifier signal 114.

In one embodiment, the RFID reader 120 is a small clip-on device that can be attached to a WiFi enabled cell phone. In this embodiment, RFID reader 120 is capable of reading tags in the proximate area and utilizing the cell phone/WiFi to transmit these tags as active tags, which gives one or more devices (e.g., an RF switch 130, discussed below) the ability to read these tags and provide the information to various other devices (e.g., an asset monitoring device). In this manner, the software and/or hardware on cell phone/device utilizes less power, but enables devices on the other end to use RFID passive tag information for various purposes (e.g., asset location, asset tracking, and the like).

In another embodiment, RFID reader 120 includes an antenna 1210 coupled to signal generator 1220 and module 1230. Antenna 1210 may be, for example, any device capable of transmitting charging RF signals and receiving identifier signals. In one embodiment, antenna 1210 is suitably configured to transmit substantially continuous charging RF signal 118 to one or more external devices (e.g., RFID passive tags 110). In another embodiment, antenna 1210 is suitably configured to receive substantially continuous identifier signals 114 from one or more external devices (e.g., passive tags 110).

RFID reader 120, in one embodiment, is coupled to an RF switch 130. RF switch 130 may comprise one or more processors accompanied by storage units, displays, input/output devices, an operating system, database management software, networking software, and the like. Such systems are well known in the art, and need not be described in detail. RF switch 130 may be configured as a general purpose computer, a network switch, or any other such network host.

RF switch 130, in one embodiment, is coupled to a network 140 (e.g., an Ethernet network coupled to one or more other networks or devices), wherein network 140 communicates with one or more enterprise applications 150 and/or one or more servers 160, each of which is well-known in the art. Although FIG. 1 illustrates a single enterprise application and a single server 160, any number of additional enterprise applications 150, servers 160, and/or other network components may also be present in system 100.

System 100, when operating in accordance with the present invention, generally includes an environment 1000 (e.g., a store, warehouse, or any other predefined area or volume, which may of course include various doors, windows, and other points of ingress and egress). One or more RFID passive tags 110 and one or more RFID readers 120 are provided within environment 1000. RFID passive tags 110 are preferably distributed throughout environment 1000 such that at least one of RFID passive tags 110 is within the operational range of RFID reader 120. In this regard, it is preferred that RFID passive tags 110 are substantially stationary (e.g., secured to walls, floors, ceilings, or other internal structures), but in various embodiments may be relocated or portable, depending upon the application. In one embodiment, one or more RFID passive tags 110 are placed within other electronic components within environment 1000, such as wireless switches, routers, access ports, access points, and the like. RFID passive tags 110 may be distributed in a uniform, geometrical pattern (e.g., a grid), or may be placed in any suitable non-uniform arrangement that provides the desired coverage. The exact positions of RFID passive tags 110 may be known or unknown.

In operation, RFID reader 120 transmits substantially continuous charging RF signal 118 within environment 1000. In response to receiving substantially continuous charging RF signal 118, each of RFID passive tags 110 is charged and transmits substantially continuous identifier signal 114. RFID reader 120 receives substantially continuous identifier signal 114 and is capable of determining a location of each RFID passive tag 110 and/or an asset associated with each RFID passive tag 110 that is transmitting a respective substantially continuous identifier signal 114. Accordingly, each respective RFID passive tag 110 is visible to RFID reader 120 as an “active tag.” In other words, by substantially continuously transmitting a respective substantially continuous identifier signal 114, each RFID passive tag 110 mimics an RFID active tag.

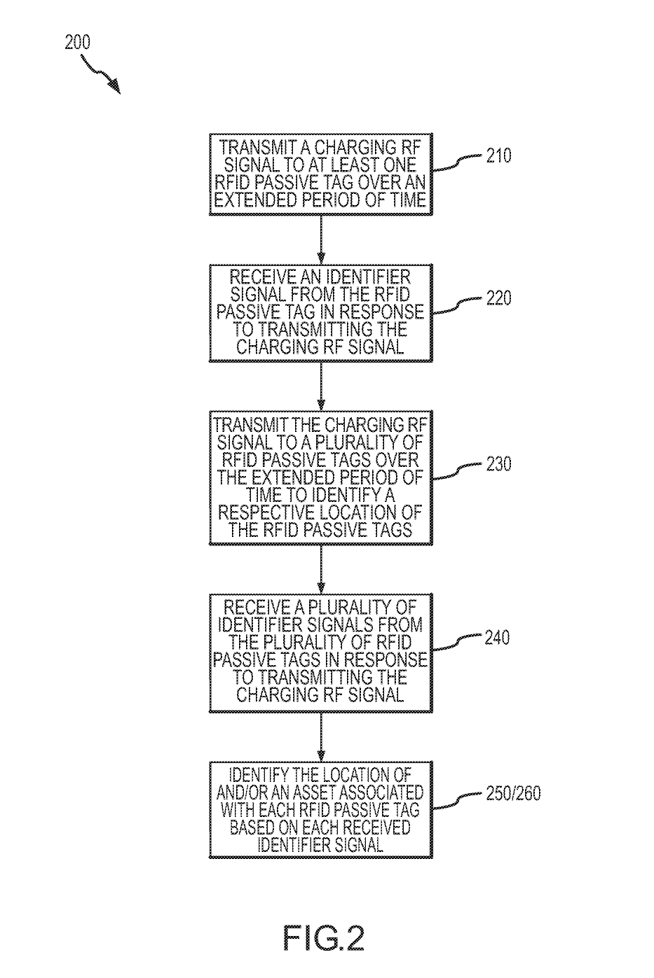

FIG. 2 is a flow diagram representing one embodiment of a method 200 for enabling an RFID passive tag (e.g., RFID passive tag 110) to be visible as an RFID active tag to another device (e.g., RFID reader 120). Method 200, in one embodiment, initiates by RFID reader 120 transmitting a substantially continuous charging RF signal (e.g., substantially continuous charging RF signal 118) to an RFID passive tag (e.g., RFID passive tag 110) over an extended period of time (step 210). In response to transmitting substantially continuous charging RF signal 118, method 200 includes RFID reader 120 receiving a substantially continuous identifier signal 114 from RFID passive tag 110 (step 220).

In another embodiment, method 200 includes RFID reader 120 transmitting a substantially continuous charging RF signal (e.g., substantially continuous charging RF signal 118) to a plurality of RFID passive tags 110 over the extended period of time, wherein the plurality is comprised of two or more RFID passive tags 110 (step 230). In response to transmitting substantially continuous charging RF signal 118, method 200 includes RFID reader 120 receiving a substantially continuous identifier signal 114 from each respective RFID passive tag 110 (step 240). In other words, RFID reader 120 transmits a charging RF signal and receives a plurality of substantially continuous identifier signals 114.

As used herein, the terms “extended period of time” includes, but is not limited to, a period extended over the useful life of an RFID passive device 110. In one embodiment, an extended period of time includes the time from when an item including RFID device 110 is first detected within a facility until the time the item leaves the facility. For example, from the time an item including RFID passive device 110 enters a warehouse until the time the item is shipped to a customer.

Method 200, in one embodiment, includes RFID reader 120 identifying the location of each RFID passive tag 110 based on the information contained within each respective substantially continuous identifier signal 114 (step 250). In another embodiment, method 200 includes RFID 120 identifying an asset associated with each RFID passive tag 110 based on the information contained within each respective substantially continuous identifier signal 114 (step 260). In yet another embodiment, method 200 includes RFID reader 120 identifying the location of each RFID passive tag 110 (step 250) and identifying an asset associated with each RFID passive tag 110 (step 260) based on the information contained within each respective substantially continuous identifier signal 114.

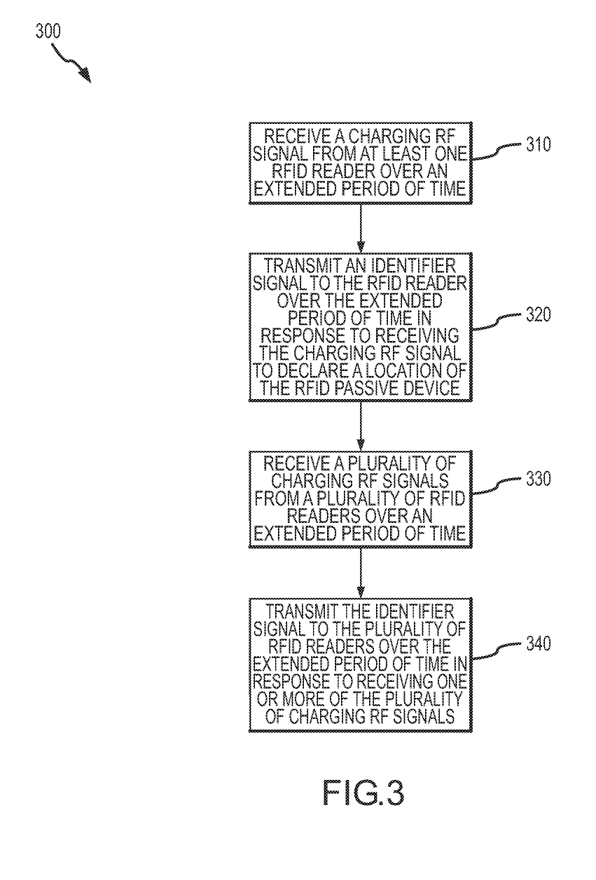

FIG. 3 is a flow diagram representing another embodiment of a method 300 for enabling an RFID passive tag (e.g., RFID passive tag 110) to be visible as an RFID active tag to another device (e.g., RFID reader 120). Method 300, in one embodiment, initiates by RFID passive tag 110 receiving a substantially continuous charging RF signal (e.g., substantially continuous charging RF signal 118) from an RFID reader (e.g., RFID reader 120) over an extended period of time (step 310). In response to receiving substantially continuous charging RF signal 118, method 200 includes RFID passive tag 110 transmitting a substantially continuous identifier signal 114 to RFID reader 120 (step 320).

In another embodiment, method 300 includes an RFID passive tag 110 receiving a plurality of substantially continuous charging RF signals (e.g., substantially continuous charging RF signals 118) from a plurality of RFID readers 120 over the extended period of time, wherein the plurality is comprised of two or more RFID readers 120 (step 330). In response to receiving the plurality of substantially continuous charging RF signals 118, method 200 includes RFID passive tag 110 transmitting a substantially continuous identifier signal 114 to each respective RFID reader 120 (step 340). In other words, RFID passive tag 110 receives a plurality of substantially continuous charging RF signals 118 and transmits an identifier signal 114 in response to at least one charging RF signal 118.

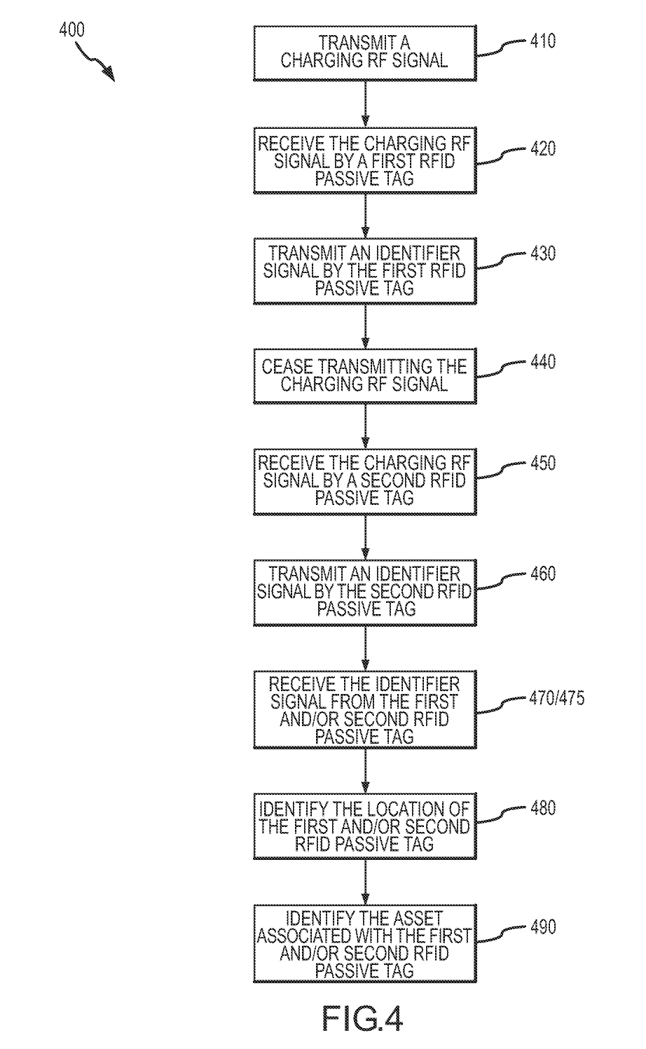

FIG. 4 is a flow diagram representing yet another embodiment of a method 400 for enabling an RFID passive tag (e.g., RFID passive tag 110) to be visible as an RFID active tag to an RFID reader (e.g., RFID reader 120). Method 400, in one embodiment, initiates by RFID reader 120 transmitting a substantially continuous charging RF signal (e.g., substantially continuous charging RF signal 118) to a first RFID passive tag (e.g., RFID passive tag 110) over an extended period of time (step 410). Moreover, method 400 includes RFID passive tag 110 receiving substantially continuous charging RF signal 118 from RFID reader 120 over the extended period of time (step 420).

In response to RFID passive tag 110 receiving substantially continuous charging RF signal 118 from RFID reader 120, method 400 includes the first RFID passive tag 110 transmitting a substantially continuous identifier signal 114 to RFID reader 120 (step 430). By substantially continuously transmitting substantially continuous identifier signal 114, the first RFID passive tag 110 is visible to RFID reader 120 as an active tag or, in other words, mimics an active tag. Method 400, in another embodiment, includes RFID reader 120 ceasing to transmit substantially continuous charging RF signal 118 such that RFID passive tag 110 is no longer visible as an active tag (i.e., no longer mimics an active tag) (step 440).

Method 400, in another embodiment, includes a second RFID passive tag 110 receiving substantially continuous charging RF signal 118 over the extended period of time (step 450). Similar to the first RFID passive tag 110 discussed above, method 400 includes the second RFID passive tag 110 transmitting a substantially continuous identifier signal 114 to RFID reader 120 (step 460). By substantially continuously transmitting substantially continuous identifier signal 114, the second RFID passive tag 110 is visible to RFID reader 120 as an active tag or, in other words, mimics an active tag.

In one embodiment, method 400 includes RFID reader 120 receiving the substantially continuous identifier signal 114 from the first RFID passive tag 110 (step 470) and/or receiving the substantially continuous identifier signal 114 from the second RFID passive tag 110 (step 475). In response to step 470 and/or step 475, method 400 includes RFID reader 120 identifying the location of the first RFID passive tag 110 and/or the second RFID passive tag 110 (step 480), and/or identifying the asset associated with the first RFID passive tag 110 and/or the second RFID passive tag 110 (step 490).

It should be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

I claim:

1. A radio frequency identification (RFID) system comprising:
at least one RFID passive tag configured to receive a substantially continuous charging radio frequency (RF) signal and transmit a substantially continuous identifier signal in response to receiving the substantially continuous charging RF signal; and
an RFID reader configured to transmit the substantially continuous charging RF signal and receive the substantially continuous identifier signal, wherein the at least one RFID passive tag is visible as an RFID active tag to the RFID reader when transmitting the substantially continuous identifier signal.

2. The RFID system of claim 1, wherein the at least one RFID passive tag is further configured to receive the substantially continuous charging RF signal and transmit the substantially continuous identifier signal for an extended period of time.

3. The RFID system of claim 1, further comprising:
a plurality of RFID passive tags configured to receive the substantially continuous charging RF signal and to transmit a respective substantially continuous identifier signal such that each RFID passive tag is visible as an RFID active tag when transmitting its respective identifier signal.

4. The RFID system of claim 3, wherein the plurality of RFID passive tags are each further configured to receive the substantially continuous charging RF signal and to transmit their respective substantially continuous identifier signal for an extended period of time.

5. A method for enabling a radio frequency identification (RFID) passive tag to be visible as an RFID active tag, the method comprising the steps of:
transmitting, by an RFID reader, a substantially continuous charging radio frequency (RF) signal to at least one RFID passive tag; and
receiving, by the RFID reader, a substantially continuous identifier signal from the at least one RFID passive tag in response to transmitting the charging RF signal, wherein the transmitting and receiving steps occur over an extended period of time to identify one of a location of and a asset associated to the at least one RFID passive tag.

6. The method of claim 5, wherein the transmitting step comprises the step of transmitting the substantially continuous charging RF signal to a plurality of RFID passive tags over the extended period of time, and the receiving step comprises receiving a plurality of substantially continuous identifier signals from the plurality of RFID passive tags over the extended period of time in response to transmitting the charging RF signal to identify one of a respective location for and asset for each of the plurality of RFID passive tags.

7. A method for enabling an RFID passive tag to be visible as an RFID active tag, the method comprising the steps of
transmitting, by an RFID reader, a substantially continuous charging RF signal;
receiving, by a first RFID passive tag, the substantially continuous charging RF signal; and
transmitting, by the first RFID passive tag, a first substantially continuous identifier signal in response to receiving the substantially continuous charging RF signal.

8. The method of claim 7, wherein the first RFID passive tag is visible to the RFID reader as an RFID active tag when transmitting the first substantially continuous identifier signal.

9. The method of claim 7, further comprising the step of ceasing to transmit the substantially continuous charging RF signal such that the first RFID passive tag is no longer visible as an RFID active tag.

10. The method of claim 7, wherein the transmitting the substantially continuous charging RF signal step, the receiving the substantially continuous charging RF signal step, and the transmitting the first substantially continuous identifier signal step each occurs for an extended period of time.

11. The method of claim 7, further comprising the steps of:
receiving, by a second RFID passive tag, the substantially continuous charging RF signal; and
transmitting, by the second RFID passive tag, a substantially continuous second identifier signal in response to receiving the charging RF signal.

12. The method of claim 11, wherein the first RFID passive tag and the second RFID passive tag are each visible as respective RFID active tags to the RFID reader when transmitting the first substantially continuous identifier signal and the second substantially continuous identifier signal, respectively.

13. The method of claim 12, further comprising the step of ceasing to transmit the charging RF signal such that the first RFID passive tag and the second RFID passive tag are no longer visible as respective RFID active tags to the RFID reader.

14. The method of claim 11, wherein the transmitting the substantially continuous charging RF signal step, the receiving the substantially continuous charging RF signal steps, the transmitting the first substantially continuous identifier signal step, and the transmitting the second substantially continuous identifier signal step each occurs for an extended period of time.

15. The method of claim 11, further comprising the steps of:
receiving, by the RFID reader, the first substantially continuous identifier signal;
receiving, by the RFID reader, the second substantially continuous identifier signal;
substantially continuously identifying, by the RFID reader, one of a first location of the first RFID passive device and a first asset associated with the first RFID passive device based on the first substantially continuous identifier signal; and
substantially continuously identifying, by the RFID reader, one of a second location of the second RFID passive device and a second asset associated with the second RFID passive device based on the second substantially continuous identifier signal.

16. The method of claim 15, wherein the first location and the second location are substantially different locations.

17. The method of claim 15, wherein the first asset and the second asset are different assets.

18. The method of claim 7, further comprising the steps of:
receiving, by the RFID reader, the first substantially continuous identifier signal; and
substantially continuously identifying, by the RFID reader, one of a location of the first RFID passive device and a asset type associated with the first RFID passive device based on the first substantially continuous identifier signal.

19. A radio frequency identification (RFID) reader comprising:
a signal generator configured to generate a substantially continuous radio frequency (RF) charging signal;
an antenna coupled to the signal generator, the antenna configured to transmit the substantially continuous RF charging signal and to receive a first substantially continuous identifier signal from a first RFID passive device; and
a module coupled to the antenna, the module configured to determine one of a first location of the first RFID passive device and a first asset type associated with the first RFID passive device based on the first substantially continuous identifier signal.

20. The RFID reader of claim 19, wherein the antenna is further configured to receive a second substantially continuous identifier signal from a second RFID passive device, and wherein the module is further configured to determine one of a second location of the second RFID passive device and a second asset type associated with the second RFID passive device based on the second substantially continuous identifier signal.

21. A method for enabling a radio frequency identification (RFID) passive tag to be visible as an RFID active tag, the method comprising the steps of:
receiving, by an RFID passive tag, a substantially continuous charging radio frequency (RF) signal from at least one RFID reader; and
transmitting, by the RFID passive tag, a substantially continuous identifier signal to the at least one RFID reader in response to receiving the substantially continuous charging RF signal, wherein the receiving and transmitting steps occur over an extended period of time to enable a location of the RFID passive tag to be determined.

22. The method of claim 21, wherein the receiving step comprises the step of receiving a plurality of substantially continuous charging RF signals from a plurality of RFID readers over the extended period of time, and the transmitting step comprises transmitting the substantially continuous identifier signal to each the plurality of RFID readers over the extended period of time in response to receiving the plurality charging RF signals to enable a location of the RFID passive tag to be determined.
